(19) United States
(12) Patent Application Publication
(10) Pub. No.: US 2015/0253445 A1
(43) Pub. Date: Sep. 10, 2015

(54) VISUALIZATION OF SEISMIC ATTRIBUTES

(71) Applicant: WesternGeco L.L.C., Houston, TX (US)

(72) Inventors: Chuan Luo, Houston, TX (US); Oleg Mishchenko, Houston, TX (US); David Nichols, Houston, TX (US); Marvin Decker, Houston, TX (US)

(21) Appl. No.: 14/639,717

(22) Filed: Mar. 5, 2015

Related U.S. Application Data
(60) Provisional application No. 61/948,608, filed on Mar. 6, 2014.

(51) Int. Cl. G01V 1/34

(52) U.S. Cl. CPC G01V 1/345

(57) ABSTRACT

Systems, methods, and computer-readable media for visualizing a seismic attribute. The method includes obtaining data representing a seismic image based on seismic data of at least a portion of a subterranean volume, obtaining data representing a first seismic attribute calculated based on the seismic data, and determining one or more characteristics of one or more first attribute indicators based on the first seismic attribute. At least one of the one or more characteristics comprises an orientation of the one or more first attribute indicators. The method also includes displaying the one or more first attribute indicators in combination with the seismic image.

### CROSS-REFERENCE TO RELATED APPLICATIONS

This application claims priority to U.S. Provisional Patent Application Ser. No. 61/948,608, which was filed on Mar. 6, 2014. The entirety of this provisional application is incorporated herein by reference.

### BACKGROUND

Seismic data acquisition generally proceeds by geophones detecting seismic waves and producing seismic traces therefrom. The traces may include signals produced by subterranean reflection events. Reflection events are generally representative of interfaces between two types of rock with different levels of acoustic impedance, which may also be referred to as horizons. When encountering the interface, generally speaking, a portion of the seismic wave reflects back towards the surface and is subsequently detected by the geophones.

The acquired seismic data may be processed to construct an image of the subterranean domain. Seismic attributes may also be determined, based on the seismic data. For example, dip is a seismic attribute, and may be representative of the steepest angle of descent of a tilted bed or feature relative to a horizontal plane. Once calculated, such seismic attributes may be displayed. Continuing with the example of dip, portions of the seismic image may be colored, e.g., with red and blue, to indicate dip magnitude. The color may be changed in accordance with a spectrum mapped to dip magnitude. This may facilitate quality control review of the image, the attribute, or both.

However, in such quality control review, a user generally views two or more display windows in order to interpret the seismic attributes. Further, the user may be called upon to correlate arbitrarily-chosen colors, mapped to a legend of values for the attribute, in a display of a seismic image with individual attributes.

### SUMMARY

Embodiments of the present disclosure may provide a method for visualizing a seismic attribute. The method includes obtaining data representing a seismic image based on seismic data of at least a portion of a subterranean volume, and obtaining data representing a first seismic attribute calculated based on the seismic data. The method also includes determining one or more characteristics of one or more first attribute indicators based on the first seismic attribute. At least one of the one or more characteristics includes an orientation of the one or more first attribute indicators. The method further includes displaying the one or more first attribute indicators in combination with the seismic image.

In an embodiment, displaying the one or more first attribute indicators includes plotting the one or more first attribute indicators on the seismic image at or near a point in the seismic image from which the one or more characteristics of the one or more first attribute indicators are determined.

In an embodiment, the one or more characteristics further includes a dimensional size of the one or more first attribute indicators.

In an embodiment, the one or more first attribute indicators include one or more line segments, the dimensional size including a length of the one or more line segments.

In an embodiment, the one or more first attribute indicators include one or more ellipsoids, the dimensional size comprising at least two semi-axes of the one or more ellipsoids.

In an embodiment, the first seismic attribute comprises dip, and determining the one or more characteristics of the one or more attribute indicators includes determining a first dimensional size based on a dominant dip, and determining a second dimensional size based on a residual dip, or a quality metric calculated based on a combination of the dominant dip and the residual dip.

In an embodiment, obtaining the first seismic attribute includes obtaining data representing a velocity field based on the seismic data and data representing a dip field based on the seismic data, the dip field comprising a primary dip, decomposing the velocity field into at least a direction perpendicular to the primary dip, and estimating velocity variation in one or more directions non-perpendicular to the primary dip based on an anisotropic approximation of the subterranean volume. Further, displaying the one or more first indicators includes displaying a velocity field indicator oriented parallel to a v-fast direction.

In an embodiment, the method may also include obtaining data representing a second seismic attribute based on the seismic data, determining one or more characteristics of one or more second attribute indicators based on the second seismic attribute, and displaying the one or more second attribute indicators in combination with the one or more first attribute indicators and the seismic image.

In an embodiment, the one or more second attribute indicators are at least partially embedded within the one or more first attribute indicators.

In an embodiment, the one or more first attribute indicators represent dip and the one or more second attribute indicators represent a velocity field.

Embodiments of the disclosure may also provide a computing system. The computing system includes a display, one or more processors, and a memory system including one or more non-transitory computer-readable media storing instructions that, when executed by at least one of the one or more processors, cause the computing system to perform operations. The operations include obtaining data representing a seismic image based on seismic data of at least a portion of a subterranean volume, and obtaining data representing a first seismic attribute calculated based on the seismic data. The operations also include determining one or more characteristics of one or more first attribute indicators based on the first seismic attribute. At least one of the one or more characteristics includes an orientation of the one or more first attribute indicators. The operations further include displaying, using the display, the one or more first attribute indicators in combination with the seismic image.

Embodiments of the disclosure may further provide a non-transitory computer-readable medium storing instructions that, when executed by at least one processor of a computing system, cause the computing system to perform operations. The operations include obtaining data representing a seismic image based on seismic data of at least a portion of a subterranean volume, and obtaining data representing a first seismic attribute calculated based on the seismic data. The operations also include determining one or more characteristics of one or more first attribute indicators based on the first seismic attribute. At least one of the one or more characteristics includes an orientation of the one or more first attribute indicators. The operations further include displaying, the one or more first attribute indicators in combination with the seismic image.

Thus, the computing systems and methods disclosed herein are more effective methods for processing collected data that may, for example, correspond to a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIGS. 1A, 1B, 1C, 1D, 2, 3A, and 3B illustrate simplified, schematic views of an oilfield and its operation, according to an embodiment.

FIGS. 4 and 5 illustrate flowcharts of methods for visualizing a seismic attribute, according to some embodiments.

FIGS. 6A and 6B illustrate two-dimensional and three-dimensional, respectively, combined views of seismic images and seismic attribute indicators, according to an embodiment.

FIG. 7 illustrates another flowchart of a method for visualizing a seismic attribute, according to an embodiment.

FIG. 8 illustrates a combined view of a velocity-field indicator and a seismic image, according to an embodiment.

FIG. 9 illustrates a flowchart of a method for estimating a dip, according to an embodiment.

FIGS. 10A and 10B illustrate flowcharts of a method for visualizing a seismic attribute, according to an embodiment.

FIG. 11 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

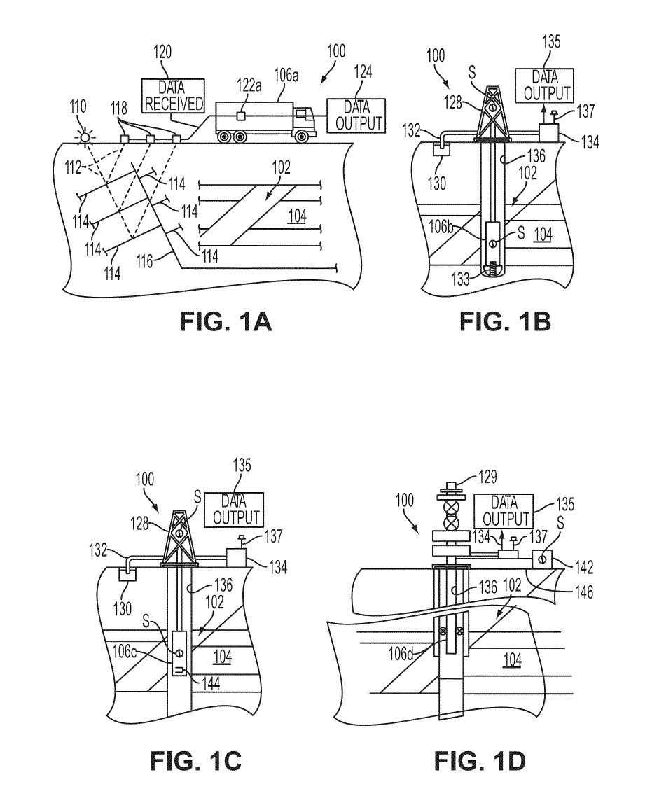

FIGS. 1A-1D illustrate simplified, schematic views of oilfield 100 having subterranean formation 102 containing reservoir 104 therein in accordance with implementations of various technologies and techniques described herein. FIG. 1A illustrates a survey operation being performed by a survey tool, such as seismic truck 106.1, to measure properties of the subterranean formation. The survey operation is a seismic survey operation for producing sound vibrations. In FIG. 1A, one such sound vibration, e.g., sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1B illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is typically filtered and returned to the mud pit. A circulating system may be used for storing, controlling, or filtering the flowing drilling mud. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produce data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 1C illustrates a wireline operation being performed by wireline tool 106.3 suspended by rig 128 and into wellbore 136 of FIG. 1B. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein.

Wireline tool 106.3 may be operatively connected to, for example, geophones 118 and a computer 122.1 of a seismic truck 106.1 of FIG. 1A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1D illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as Christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1B-1D illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1A-1D are intended to provide a brief description of an example of a field usable with oilfield application frameworks. Part of, or the entirety, of oilfield 100 may be on land, water and/or sea. Also, while a single field measured at a single location is depicted, oilfield applications may be utilized with any combination of one or more oilfields, one or more processing facilities and one or more wellsites.

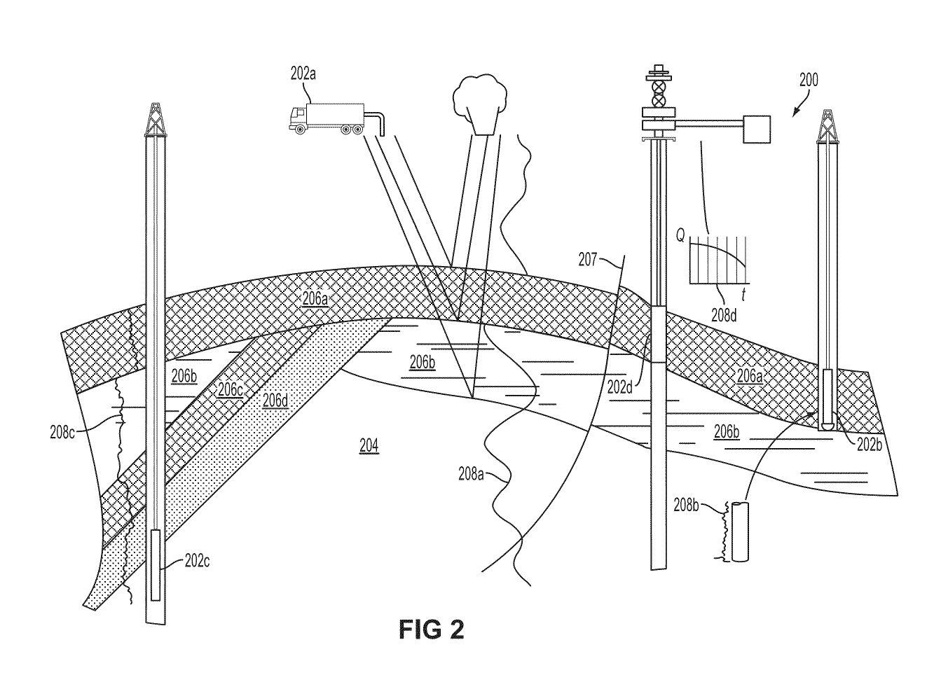

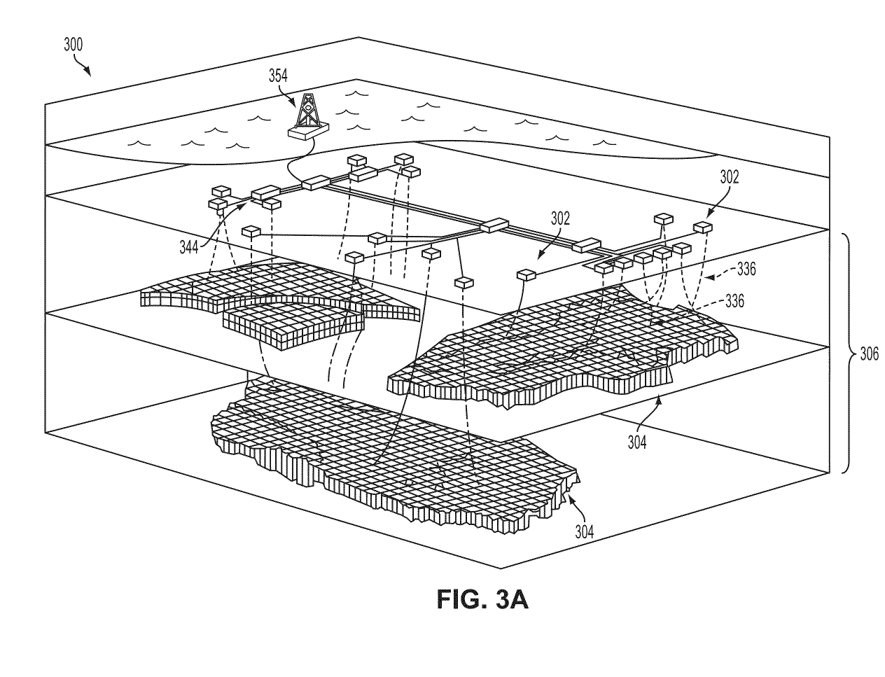

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1A-1D, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively; however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that typically provides a resistivity or other measurement of the formation at various depths.

A production decline curve or graph 208.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Typically, seismic data displayed in static data plot 208.1 from data acquisition tool 202.1 is used by a geophysicist to determine characteristics of the subterranean formations and features. The core data shown in static plot 208.2 and/or log data from well log 208.3 are typically used by a geologist to determine various characteristics of the subterranean formation. The production data from graph 208.4 is typically used by the reservoir engineer to determine fluid flow reservoir characteristics. The data analyzed by the geologist, geophysicist and the reservoir engineer may be analyzed using modeling techniques.

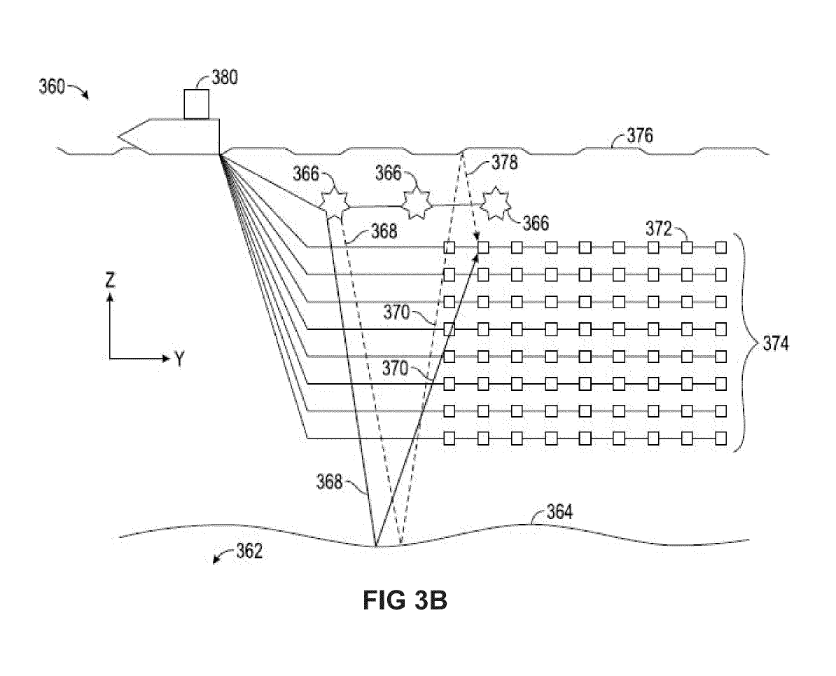

FIG. 3A illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3A is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

Attention is now directed to FIG. 3B, which illustrates a side view of a marine-based survey 360 of a subterranean subsurface 362 in accordance with one or more implementations of various techniques described herein. Subsurface 362 includes seafloor surface 364. Seismic sources 366 may include marine sources such as vibroseis or airguns, which may propagate seismic waves 368 (e.g., energy signals) into the Earth over an extended period of time or at a nearly instantaneous energy provided by impulsive sources. The seismic waves may be propagated by marine sources as a frequency sweep signal. For example, marine sources of the vibroseis type may initially emit a seismic wave at a low frequency (e.g., 5 Hz) and increase the seismic wave to a high frequency (e.g., 80-90 Hz) over time.

The component(s) of the seismic waves 368 may be reflected and converted by seafloor surface 364 (i.e., reflector), and seismic wave reflections 370 may be received by a plurality of seismic receivers 372. Seismic receivers 372 may be disposed on a plurality of streamers (i.e., streamer array 374). The seismic receivers 372 may generate electrical signals representative of the received seismic wave reflections 370. The electrical signals may be embedded with information regarding the subsurface 362 and captured as a record of seismic data.

In one implementation, each streamer may include streamer steering devices such as a bird, a deflector, a tail buoy and the like, which are not illustrated in this application. The streamer steering devices may be used to control the position of the streamers in accordance with the techniques described herein.

In one implementation, seismic wave reflections 370 may travel upward and reach the water/air interface at the water surface 376, a portion of reflections 370 may then reflect downward again (i.e., sea-surface ghost waves 378) and be received by the plurality of seismic receivers 372. The sea-surface ghost waves 378 may be referred to as surface multiples. The point on the water surface 376 at which the wave is reflected downward is generally referred to as the downward reflection point.

The electrical signals may be transmitted to a vessel 380 via transmission cables, wireless communication or the like. The vessel 380 may then transmit the electrical signals to a data processing center. Alternatively, the vessel 380 may include an onboard computer capable of processing the electrical signals (i.e., seismic data). Those skilled in the art having the benefit of this disclosure will appreciate that this illustration is highly idealized. For instance, surveys may be of formations deep beneath the surface. The formations may typically include multiple reflectors, some of which may include dipping events, and may generate multiple reflections (including wave conversion) for receipt by the seismic receivers 372. In one implementation, the seismic data may be processed to generate a seismic image of the subsurface 362.

Typically, marine seismic acquisition systems tow each streamer in streamer array 374 at the same depth (e.g., 5-10 m). However, marine based survey 360 may tow each streamer in streamer array 374 at different depths such that seismic data may be acquired and processed in a manner that avoids the effects of destructive interference due to sea-surface ghost waves. For instance, marine-based survey 360 of FIG. 3B illustrates eight streamers towed by vessel 380 at eight different depths. The depth of each streamer may be controlled and maintained using the birds disposed on each streamer.

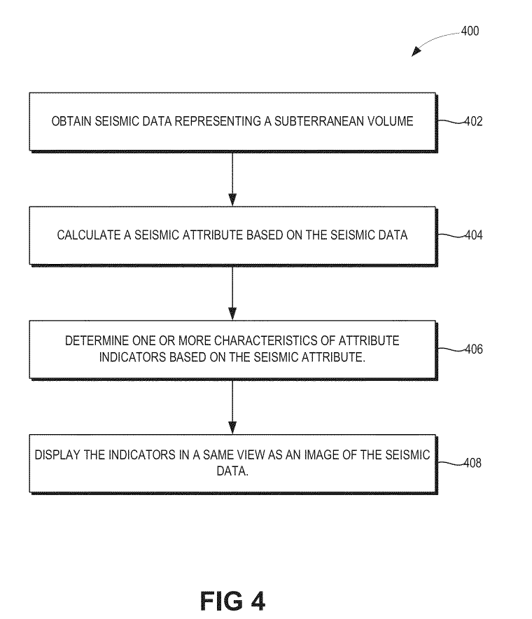

FIG. 4 illustrates a flowchart of a method 400 for visualizing a seismic attribute, according to an embodiment. In some embodiments, the seismic attribute may be dip, which may be visualized as part of a gradient representing dip magnitude (angle), e.g., a “dip field.” In other embodiments, however, any other type of seismic attribute may be visualized by operation of one or more embodiments of the method 400.

The method 400 may include obtaining seismic data representing a subterranean volume, as at 402. Obtaining at 402 may include physically acquiring the seismic data, in the form of seismic traces, using a geophone array, which may then be processed (e.g., for moveout, stacked, etc.) so as to provide one or more seismic images, e.g., according to the seismic acquisition activities discussed above. In other embodiments, obtaining at 402 may include receiving such seismic data from one or more other sources, and, for example, data stored for later use. As such, obtaining at 402 may or may not include acquisition and/or processing activities.

The method 400 may then proceed to calculating a seismic attribute based on the seismic data, as at 404. The seismic attribute may be calculated for one or more available points of the seismic image. For example, if the seismic image is provided on a grid of 6000 cubic meters, the seismic attribute may be calculated for some amount less than that size, e.g., about 3000 cubic meters. It will be appreciated that these numbers are non-limiting and simply represent one illustrative example among many contemplated. In some embodiments, the seismic attribute may be calculated for the same volume as the seismic image. Moreover, in some embodiments, a slice of the seismic image may be selected, and the seismic attribute may be calculated for one or more points of the slice, e.g., on-demand or on-the-fly. In another embodiment, the seismic attribute may be calculated for one, some, or all available slices prior to being made available to a user. Further, a user may specify a particular area at which the seismic attribute may be shown, e.g., as part of a display of a part of the slice, and the seismic attribute may be calculated for one, some, or all points in the area.

The method 400 may also include determining one or more characteristics of attribute indicators based on the seismic attribute, as at 406. Generally, attribute indicators may be any type of visualization primitives, such as lines, ellipsoids, etc. that convey information to the user. The characteristics of the attribute indicators that may be determined at 406 may include an orientation of the attribute indicators, which may be, in an embodiment, representative of a dip magnitude calculated based on the seismic data for a particular point in the seismic image. Another characteristic may be a geometrical size or shape attribute. Further, at least some of the characteristics may be selected based on a view of the seismic image upon which the attribute indicators will be displayed (e.g., overlaid), as will be described below. For example, the color, density, and/or length of the lines may be at least partially selected based on the zoom level, color of the image, resolution of the image, etc.

The attribute indicators may be provided in two-dimensions or in three-dimensions. As an example, the attribute indicators may be provided in two-dimensions (e.g., as two-dimensional projections in a plate parallel to the viewing plane) in the context of two-dimensional seismic images, and in three-dimensions in the context of three-dimensional seismic images, but in other examples, may be provided irrespective of the dimension of the seismic image. In a two-dimensional embodiment, the attribute indicators may be line segments, and the length of the line or arrow may be representative of the strength, magnitude, or another value associated with the seismic attribute at or near the point where the indicator is plotted. In a three-dimensional embodiment, the attribute indicators may be ellipsoids, with one or more axial dimensions representing different values associated with the seismic attribute, as will be described in greater detail below. Further, other shapes for the attribute indicators in either the two or three dimensional examples may be used.

The seismic attribute may then be displayed in combination with the seismic image. For example, the method 400 may include displaying the attribute indicators in the same view as the seismic data, as at 408. In some embodiments, the attribute indicators may be applied, overlaid, superimposed, or otherwise displayed along with the seismic image from which the dip is calculated. Since the visual representation, according to the determined characteristics, e.g., size, position, orientation, etc., of the attribute indicators is associated with the value(s) of the seismic attribute(s) at or near the position of the attribute indicators, the attribute indicators may provide a quick, intuitive quality control correlation between the seismic attribute and the seismic image.

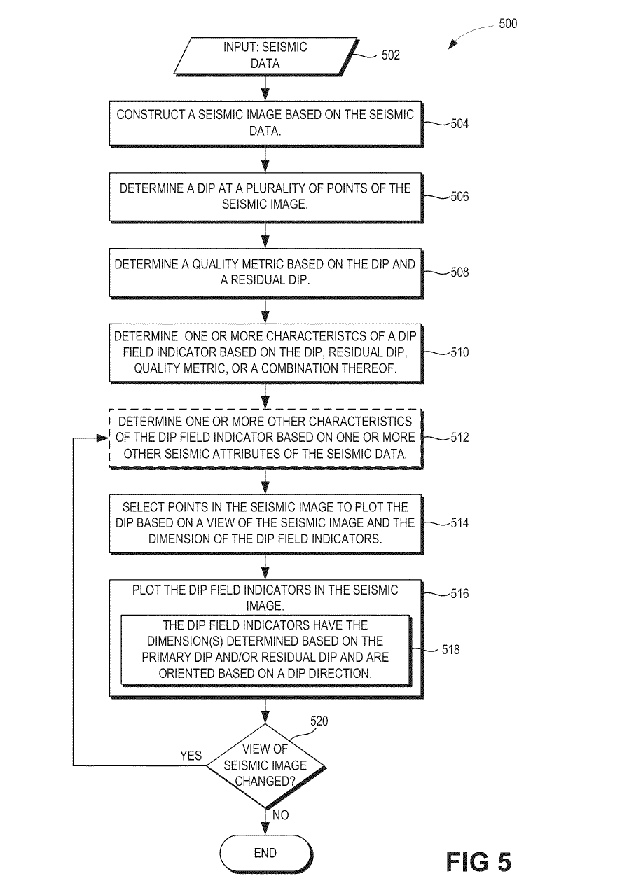

FIG. 5 illustrates a more detailed flowchart of a method 500 for visualizing a seismic attribute, according to an embodiment. The method 500 may begin receiving input from a source of seismic data that may represent a subterranean domain, as at 502. The seismic data may provide information for the construction of at least a partial seismic image of the subterranean domain, as at 504, which may have one or more seismic processing procedures applied thereto.

For purposes of illustration, the following discussion will focus on dip as the seismic attribute. It will be appreciated, however, that the seismic attribute visualized according to embodiments of the method 500 may be or include any other seismic attribute, and thus the attribute being dip is not to be considered limiting unless otherwise expressly stated herein.

The method 500 may also include determining the seismic attribute, for example, dip, at a plurality of points of the seismic image, as at 506. The plurality of points may be selected based on a view of the seismic image. For example, if a certain slice of the seismic data, or a certain area, etc., is selected, the seismic attribute may be calculated for this portion; however, in other embodiments, the seismic attribute may be calculated for some or all of the seismic image, e.g., regardless of any particular selected view of the seismic image.

Determining the dip at 506 may also include selecting between two or more signals for the dip, so as to differentiate between a “primary” or “dominant” dip and a lower-energy “residual” dip. Relatedly, a quality metric of the dip may be characterized by a combination, e.g., a ratio of the dip magnitude to the total magnitude (or the residual magnitude) of the signal representing a given point. The quality may be determined as part of the method 500, e.g., as at 508. One example of primary dip and residual dip may be apparent in a case where a simple dome has a smaller dome extending from it. The dip quality may be generally high for the dome, away from the second, smaller dome. Further, the dip quality may be generally high for the second dome, away from the intersection with the first, larger dome. However, at the intersection, the dip attribute may contain a mixture of the dips for the first and second domes, which may not be equal. The dip attribute for the larger dome may be dominant; however, the presence of the residual dip provided by the smaller dome may lower the quality of the dip attribute at the intersection.

The method 500 may then proceed to determining one or more characteristics of a dip field indicator based on the quality metric, primary dip, residual dip, or a combination thereof, as at 510. For example, the position of the dip field indicator may be set according to the location of the information from which it is calculated in the seismic image. The orientation of the dip field indicator may be set as parallel to the dip direction. The length, thickness, diameter, semi-diameter(s), etc. may be set according to any of these factors, combinations thereof, and/or others.

In some embodiments, the method 500 may be configured to display two or more seismic attributes in combination with the seismic image. Accordingly, the method 500 may include determining one or more other characteristics of the dip field indicator(s) based on one or more other seismic attributes of the seismic data, as at 512. Continuing with the example of the attribute indicators being dip field indicators, a velocity field may be determined based on the dip. An anisotropic velocity field with spatially varying symmetry may be derived from a dip field, such as a velocity field with tilted transverse isotropy or an orthorhombic velocity field. The local symmetry axes of the velocity field may be rendered using dip field indicators with additional secondary attributes that further describe the velocity field, as will be described in greater detail below. In other embodiments, separate, second indicators may be provided to show the second seismic attribute.

The method 500 may also include selecting points in the seismic image to plot the dip based on a view of the seismic image and the dimension of the dip field indicators, as at 514. In some embodiments, the seismic image may be of a relatively high resolution, and thus many grid elements of the seismic image may be visible at a level of zoom. Displaying dip indicators for each element might result in a large number of dip indicators being plotted, which may impair the ability of a user to interpret the image (e.g., the image is cluttered). Accordingly, a subset of the grid elements for which the dip indicators are displayed may be selected at 514. Such selection may proceed according to any algorithm. For example, selecting at 514 may start with a maximum number of points to plot, regardless of zoom level, but in other embodiments, may dynamically determine the number of indicators to plot based on other factors such as a length of the dip field indicators to be plotted. In either example, the method 500 may seek to avoid indicators crossing or otherwise colliding in the image. In some embodiments, however, some collisions may be allowed. Further, the indicators may be plotted generally equally spaced apart, but in other embodiments, may be closer together in some locations, e.g., to represent relatively sharp changes in dip in a particular area.

The method 500 may also include plotting the dip indicators in the seismic image, as at 516. In some embodiments, such plotting may include scaling the size of the dip indicators (in addition to or in lieu of selecting the number of grid elements for which to plot the dip indicators at 514) to the viewing window. Further, the color, density, etc., of the dip indicators may be selected at least partially based on the background color, brightness, contrast, etc., of the seismic image, so as to enhance viewability. In some embodiments, however, the color and/or density may be representative of another seismic attribute displayed embedded in the dip indicator, as will be described below. Accordingly, as indicated at 518, the dip field indicators may have the dimension(s) determined based on the primary dip and/or residual dip and may be oriented based on the primary dip direction.

In some embodiments, the method 500 may additionally determine if a view of the seismic image has changed, as at 520. For example, if a user zooms in or out, pans, rotates, or otherwise moves to a different view of a slice of the seismic image, or moves to a different seismic slice, the method 500 may determine that the view of the seismic image has changed (i.e., ‘YES’ determination for 520). The method 500 may thus loop back to selecting points in the seismic image to plot the dip, at 514, or may loop back to another location, e.g., depending on how and/or when the dip field is determined (e.g., on-demand, ahead of time, etc.). Otherwise (i.e., ‘NO’ determination for 520) the method 500 may proceed to one or more other processes (not shown) or may end.

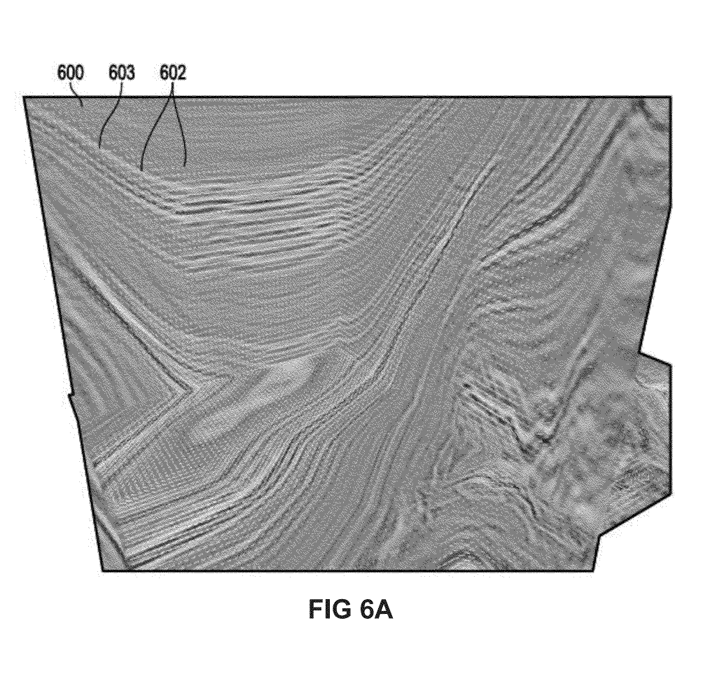

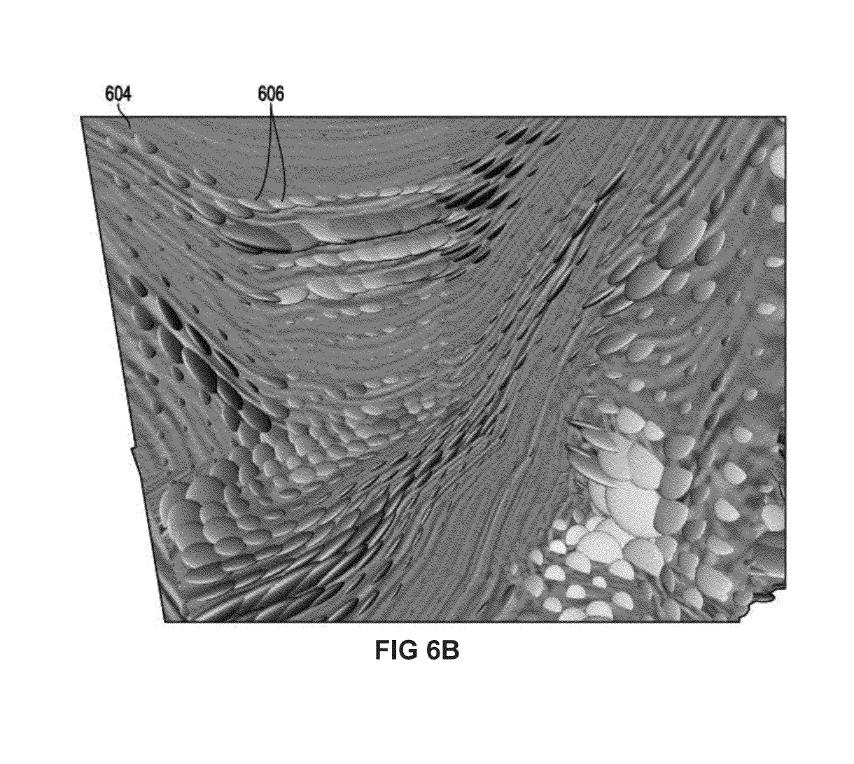

FIG. 6A illustrates an example of a combined display of a two-dimensional seismic image 600 with a plurality of indicators 602 displayed therewith. In this two-dimensional embodiment, the dip indicators 602 are oriented in the direction of a projection of the dip angle of an associated horizon 603 of the seismic image, into the viewing plane or slice shown. Similarly, FIG. 6B illustrates an example of a combined display of a three-dimensional seismic image 604 with a plurality of indicators 606 displayed therewith. In an embodiment, the three-dimensional indicators 606 may be tri-axial ellipsoids, although, in some embodiments, two or more of the semi-diameters of the ellipsoids may be equal, whether by constraint or because two values of an attribute displayed have the same value. The indicators 602, 606 may also have one or more other characteristics, such as color, thickness, shape, dimension, density, or the like, which may be displayed to represent one or more seismic attributes in a location of the seismic image.

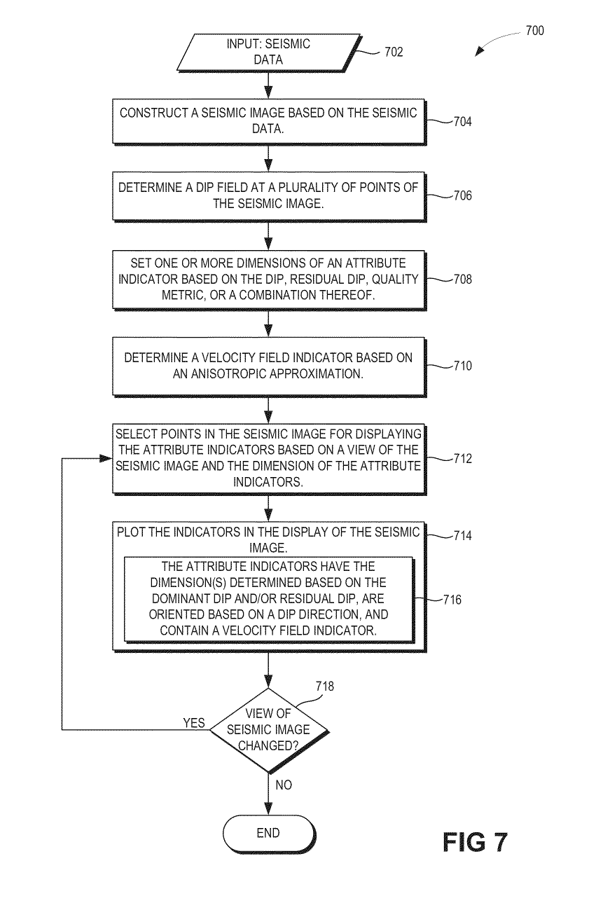

FIG. 7 illustrates another flowchart of a method 700 of visualizing a seismic attribute, according to an embodiment. In the illustrated embodiment, the method 700 may provide for visualizing a velocity field, e.g., calculated using one or more anisotropic approximation regimes (e.g., tilted orthorhombic). Further, the velocity field may be visualized in the context of a dip field, as well as the seismic image, which may further facilitate intuitive quality control checking.

For example, the method 700 may begin by receiving (or otherwise obtaining) seismic data as input, as at 702, and constructing a seismic image based on the seismic data, as at 704. The method 700 may then proceed to determining a dip field at a plurality of points of the seismic image, as at 706. Determining the dip field may include determining the dip (e.g., primary dip and/or residual dip), dip quality, and/or the like. Further, the method 700 may also include setting one or more dimensions of an attribute indicator based on the primary dip, the residual dip, a dip quality metric, or a combination thereof, e.g., as explained above with reference to FIG. 5. Additionally, the method 700 may include setting one or more characteristics (e.g., orientation, size, shape, color, etc.) of the attribute indicators based on the dominant dip, residual dip, dip quality, and/or the like.

The method 700 may also include determining a velocity field indicator, as at 710. Determining the velocity field indicator at 710 may include decomposing a velocity field into a direction perpendicular to the dominate dipping plane, e.g., as determined at 706. Determining at 710 may also include estimating a velocity variation in non-perpendicular directions based on an anisotropic approximation. In some embodiments, the anisotropic approximation may be a tilted orthorhombic anisotropic approximation. In such case, the velocity field indicator may be a “texture” representing the velocity variation and/or the fast velocity (“v-fast”) direction. A texture in this context may be an image with, for example, a particular pattern, which may be applied to visualization primitives (such as the attribute indicators), and, as a result, may facilitate discernment of direction and/or orientation of the primitive. In some embodiments, the velocity field indicator may be a separate indicator or set of indicators, which may align with the v-fast direction, as estimated. In other embodiments, the velocity field indicator may resemble a strut that extends across the attribute indicator, which represents the v-fast direction, or a set of lines similar to longitude lines, extending along the surface of an ellipsoidal dip indicator in the v-fast direction. Furthermore, other velocity field indicators may be provided for other anisotropic approximation regimes, such as transverse isotropic, tilted, transverse isotropic, etc.

With the attribute indicator and/or the velocity field indicator established, the method 700 may proceed similarly to the method 500 discussed above with reference to FIG. 5. Thus, for example, the method 700 may include selecting points in the seismic image for displaying the attribute and/or velocity field indicators, e.g., based on the view of the seismic image and the dimension of either or both types of indicators, as at 712. As such, the method 700 may include balancing displaying additional indicators, for more detailed display of the attribute, with the visualization becoming cluttered. When displayed, the attribute indicators may have the dimension(s) determined based on the dominant dip and/or residual dip, may be oriented based on a dip direction, and may contain the velocity field indicator, e.g., at least partially within the individual attribute indicators. Moreover, should the view change, at 718, the method 700 may determine such change has occurred, and may adjust the view of the indicators commensurately, e.g., in real-time.

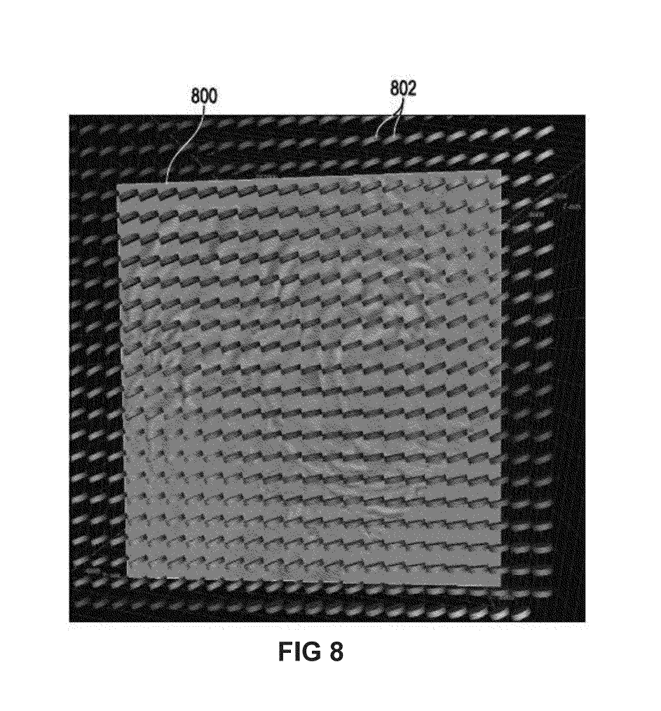

FIG. 8 illustrates a view of a combined display of a seismic image 800, which may be a seismic stack or a migrated and stacked seismic image, to name two examples, and a plurality of velocity field indicators 802. The seismic image 800 may be the seismic image from which the dip field indicators 802 are calculated. As shown, the velocity field indicators 802 may be three-dimensional and medallion-shaped. Further, the velocity field indicators 802 may be oriented along a v-fast direction, e.g., a direction along which a seismic wave propagates most quickly, and may be overlaid or otherwise displayed along with the seismic image 800, as shown.

Embodiments of the present disclosure may also provide adaptive techniques and methods for dip estimation. In some embodiments, the dip estimation methods are based on a smoothed structure tensor of a seismic stack. In some embodiments, the dip estimation methods produce a smooth unaliased dip field. In some embodiments, the dip estimation methods create high fidelity in steep dips. In some embodiments, the dip estimation methods are not limited to steep angles, e.g., 75 degrees or more. In some embodiments, the dip estimation methods utilize the ratio of the residual versus dominant eigenvalues to selectively enhance planarity of the adaptively-selected windows based on the fact that dip field is well defined on planar structures. In some embodiments, to smooth a dip field with a planar structure, the smoothing length may be scaled by the factor λ₁/(λ₁-λ₂), i.e., the inverse of planarity, to smooth noisy regions while preserving planar features.

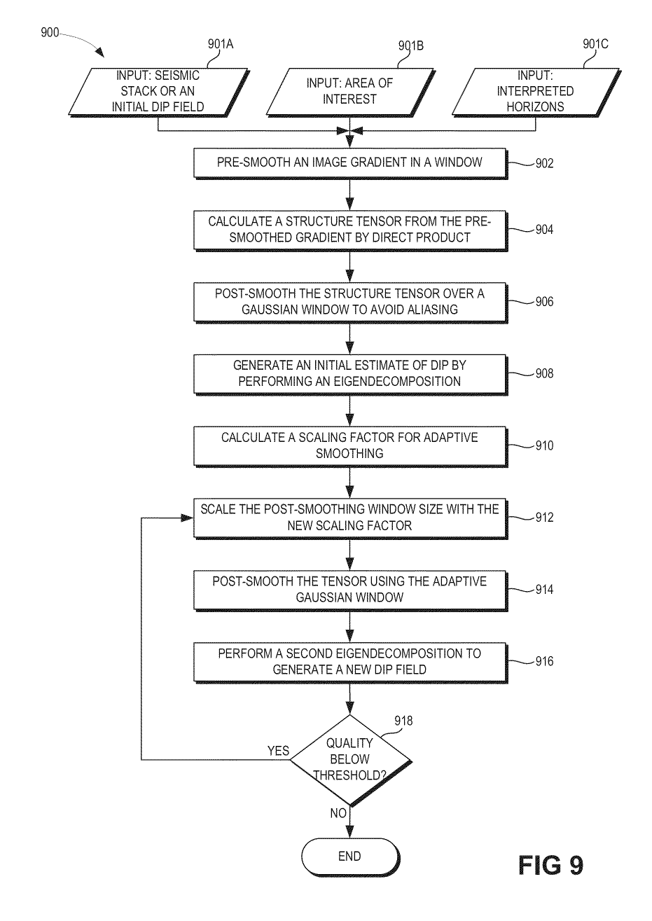

For example, FIG. 9 illustrates a flowchart of a method 900 for estimating a dip field, according to an embodiment. The method 900 may be used as part of one or more embodiments of the foregoing methods 400, 500, and/or 700 to determine the dip field.

The method 900 may receive, as input, seismic data, e.g., in the form of a seismic stack or an initial dip field, as at 901A. The method 900 may also receive, as input, data representing an area of interest, e.g., as selected or otherwise defined by a user, as at 901B. The method 900 may further include receiving one or more interpreted horizons in the seismic data as input, as at 901C.

The method 900 may then proceed to a performing a first smoothing (“pre-smoothing”) of an image gradient in a window of a portion of the seismic data, as at 902. The window size may be arbitrarily chosen, e.g., as a default which may be related to previous dynamically-sized windows, otherwise estimated, or chosen according to a predefined size. The method 900 may then proceed to calculating a structure tensor from the pre-smoothed gradient, e.g., by direct product, as at 904.

The method 900 may also include performing a second smoothing (“post-smoothing”) operation of the structure tensor over a Gaussian window, e.g., to avoid aliasing, as at 906. The method 900 may then proceed to generating an initial estimate of dip by performing an eigendecomposition of the pre-smooth structure tensor, as at 908.

The method 900 may then proceed to calculating a scaling factor for adaptive smoothing, as at 910. For example, the scaling factor may be determined using the eigendecomposition of the structure tensor in the initial window at 904. Qualitatively, this may serve to determine if a high level of residual dip is present which may result in the structure tensor inaccurately characterizing the gradient of the dip field. If such residual dip is present, the window may be increased in size to reduce the effect of localized artefacts that may contribute to residual dip. Accordingly, calculating the scaling factor at 910 may include determining a ratio based on a combination of the first and second eigenvalues of the structure tensor. For example, the scaling factor may be λ₁/(λ₁-λ₂), in which the first and second eigenvalues (λ₁>λ₂> . . . >λₙ) may be representative of the gradient change directions provided by the primary dip and residual dip, respectively.

The method 900 may also include scaling the post-smoothing window size, as at 912, e.g., by multiplying one or more dimensions of the post-smoothing window by the scaling factor determined based on the comparison of the residual dip and dominant dip, which results in an adaptive Gaussian window. With the Gaussian window scaled, the method 900 may proceed to post-smoothing the structural tensor using the adaptive Gaussian window, as at 914.

The method 900 may also include performing a second eigendecomposition to generate a new dip field based on the scaled Gaussian window, as at 916. In some embodiments, the method 900 may repeat the scaling and post-smoothing. For example, the method 900 may include, as at 918, if the measure of quality (e.g., a normalized quotient between dominant and residual dip) is below a minimum quality threshold and the last smoothing window was below a maximum window for adaptive smoothing. If it is (determination at 918 is ‘YES’) the method 900 may resmooth the structure tensor, e.g., by returning to block 912 and repeating the scaling 912, post-smoothing 914, and second eigendecomposition at 916. If the quality is above the threshold (determination at 918 is ‘NO’), the method 900 may terminate.

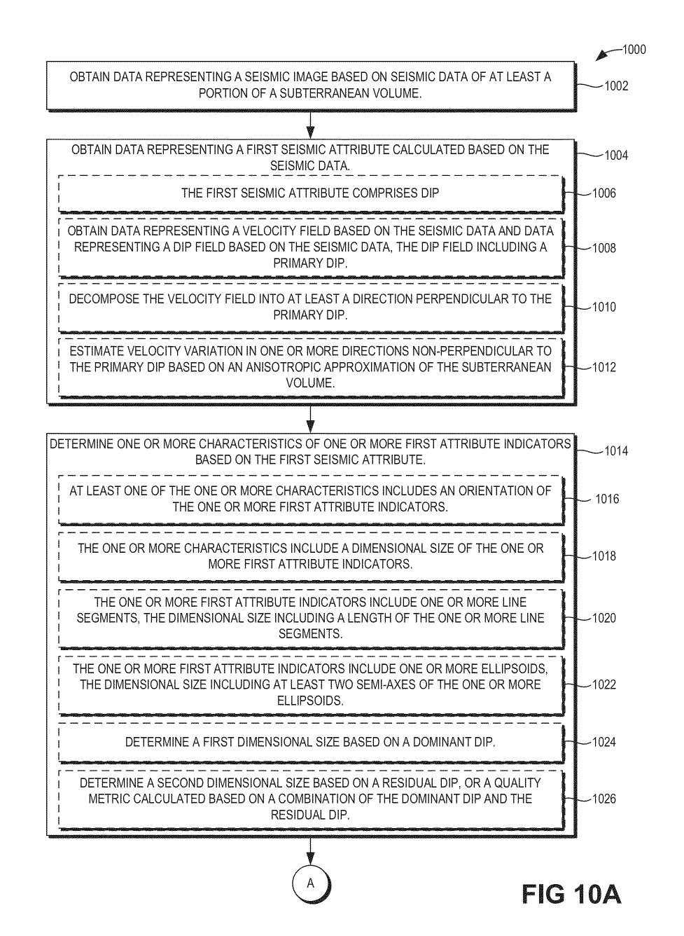

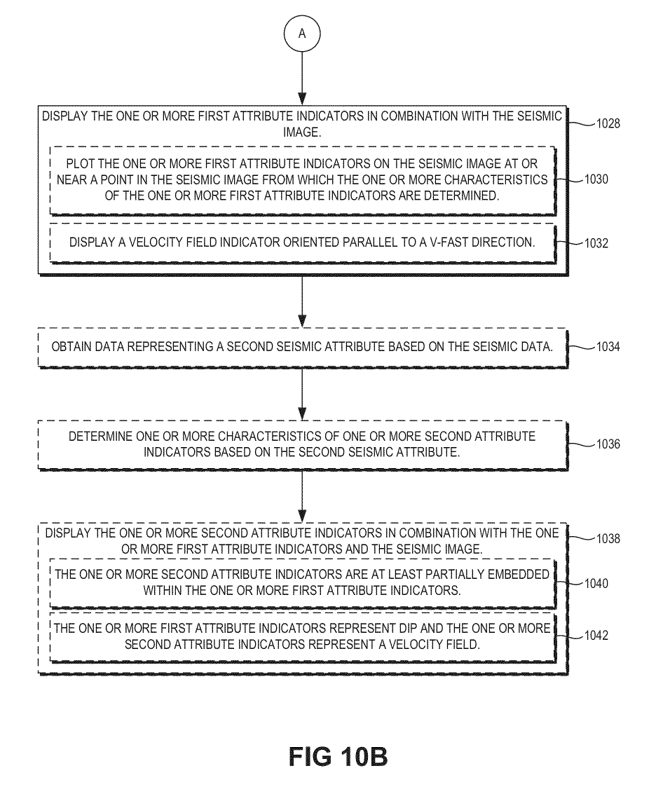

Attention is now directed to FIGS. 10A and 10B, which illustrate a flowchart depicting a method 1000 for visualizing a seismic attribute, in accordance with some embodiments. Some operations in method 1000 may be combined and/or the order of some operations may be changed. Further, some operations in method 1000 may be combined with aspects of the example workflows of FIGS. 1-9, and/or the order of some operations in method 1000 may be changed to account for incorporation of aspects of the workflow illustrated by one or more of FIGS. 1-9.

The method 1000 includes obtaining data representing a seismic image based on seismic data of at least a portion of a subterranean domain, as at 1002 (e.g., FIG. 5, 502, receiving seismic data s input).

The method 1000 may also include obtaining data representing a first seismic attribute calculated based on the seismic data, as at 1004 (e.g., FIG. 5, 506, determining a dip, which is a seismic attribute). In an embodiment, obtaining at 1004 may include obtaining data representing a velocity field based on the seismic data and data representing a dip field based on the seismic data, with the dip field including a primary dip, as at 1006 (e.g., FIG. 5, 506, determine a dip in the seismic image; FIG. 7, 710 determining a velocity field). In an embodiment, obtaining at 1004 may include obtaining data representing a velocity field based on the seismic data and data representing a dip field based on the seismic data, with the dip field including a primary dip, as at 1008 (e.g., FIG. 5, 506, determine a dip in the seismic image; FIG. 7, 710 determining a velocity field). In an embodiment, obtaining at 1004 may include decomposing the velocity field into at least a direction perpendicular to the primary dip, as at 1010 (e.g., FIG. 5, 506, determining the dip field). In an embodiment, obtaining at 1004 may also include estimating velocity variation in one or more directions non-perpendicular to the primary dip based on an anisotropic approximation of the subterranean volume, as at 1012 (e.g., FIG. 7, 710, determining a velocity field indicator based on an anisotropic approximation).

The method 1000 may also include determining one or more characteristics of one or more first attribute indicators based on the first seismic attribute, as at 1014 (e.g., FIG. 5, 510, determining a characteristic of a dip field indicator). In an embodiment, at least one of the one or more characteristics includes an orientation of the one or more first attribute indicators, as at 1016 (e.g., FIG. 5, 510, determining the characteristic(s) of the indicator, with one characteristic being orientation). In an embodiment, the one or more characteristics include a dimensional size of the one or more first attribute indicators, as at 1018 (e.g., FIG. 5, 510, determining the characteristic(s) of the indicator, with one characteristic being size). In an embodiment, the one or more first attribute indicators include one or more line segments, the dimensional size including a length of the one or more line segments, as at 1020 (e.g., FIG. 5, 510, determining the characteristic(s) of the indicator, with one characteristic being orientation; FIG. 6A, dip indicators 602 are line segments). In an embodiment, the one or more first attribute indicators include one or more ellipsoids, the dimensional size including at least two semi-axes of the one or more ellipsoids, as at 1022 (e.g., FIG. 5, 510, determining the characteristic(s) of the indicator, with one characteristic being orientation; FIG. 6B, 606, the indicators are ellipsoids). In an embodiment, determining at 1014 may further include determining a first dimensional size based on a dominant dip, as at 1024 (e.g., FIG. 5, 510, determining the characteristic(s) of the indicator; FIG. 5, 518, dimension(s) determined based on primary and/or residual dip). Further, determining at 1014 may include determining a second dimensional size based on a residual dip, or a quality metric calculated based on a combination of the dominant dip and the residual dip, as at 1026 (e.g., FIG. 5, 512, determining another characteristic of the indicators).

The method 1000 may also include displaying the one or more first attribute indicators in combination with the seismic image, as at 1028 (e.g., FIG. 5, 516, plot the dip field indicators in the seismic image). In an embodiment, displaying at 1028 may include plotting the one or more first attribute indicators on the seismic image at or near a point in the seismic image from which the one or more characteristics of the one or more first attribute indicators are determined, as at 1030 (e.g., FIG. 5, 514, selecting points to plot the dip; FIG. 5, 516, plotting the indicators). In an embodiment, displaying at 1028 may include displaying a velocity field indicator oriented parallel to a v-fast direction, as at 1032 (e.g., FIG. 7, 716, the indicators contain a velocity field indicator).

In an embodiment, the method 1000 may also include obtaining data representing a second seismic attribute based on the seismic data, as at 1034 (e.g., FIG. 7, 710 determining a velocity field indicator based on an anisotropic approximation). In an embodiment, the method 1000 may further include determining one or more characteristics of one or more second attribute indicators based on the second seismic attribute, as at 1036 (e.g., FIG. 5, 512, determining other characteristics for the dip field indicators based on other attributes; FIG. 7, 710, determining the velocity field indicators). Further, in an embodiment, the method 1000 may include displaying the one or more second attribute indicators in combination with the one or more first attribute indicators and the seismic image, as at 1038 (e.g., FIG. 7, 714, plotting the velocity field indicators). In an embodiment, the one or more second attribute indicators are at least partially embedded within the one or more first attribute indicators, as at 1040 (e.g., FIG. 7, 716, characteristics of the indicators determined based on a combination of two seismic attributes). In an embodiment, the one or more first attribute indicators represent dip and the one or more second attribute indicators represent a velocity field, as at 1042 (e.g., FIG. 6A, dip field indicators; FIG. 8, velocity field indicators).

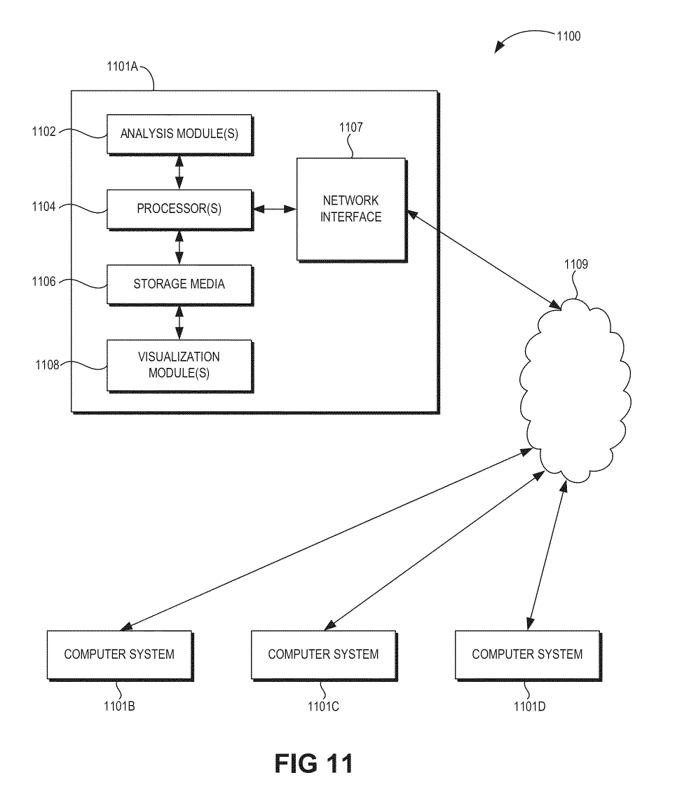

In some embodiments, any of the methods 400, 500, 700, 900, 1000 may be executed by a computing system. FIG. 11 illustrates an example of such a computing system 1100, in accordance with some embodiments. The computing system 1100 may include a computer or computer system 1101A, which may be an individual computer system 1101A or an arrangement of distributed computer systems. The computer system 1101A includes one or more analysis module(s) 1102 configured to perform various tasks according to some embodiments, such as one or more methods disclosed herein (e.g., methods 400-700, and/or combinations and/or variations thereof). To perform these various tasks, the analysis module 1102 executes independently, or in coordination with, one or more processors 1104, which is (or are) connected to one or more storage media 1106. The processor(s) 1104 is (or are) also connected to a network interface 1107 to allow the computer system 1101A to communicate over a data network 1109 with one or more additional computer systems and/or computing systems, such as 1101B, 1101C, and/or 1101D (note that computer systems 1101B, 1101C and/or 1101D may or may not share the same architecture as computer system 1101A, and may be located in different physical locations, e.g., computer systems 1101A and 1101B may be located in a processing facility, while in communication with one or more computer systems such as 1101C and/or 1101D that are located in one or more data centers, and/or located in varying countries on different continents).

A processor can include a microprocessor, microcontroller, processor module or subsystem, programmable integrated circuit, programmable gate array, or another control or computing device.

The storage media 1106 can be implemented as one or more computer-readable or machine-readable storage media. Note that while in the example embodiment of FIG. 11 storage media 1106 is depicted as within computer system 1101A, in some embodiments, storage media 1106 may be distributed within and/or across multiple internal and/or external enclosures of computing system 1101A and/or additional computing systems. Storage media 1106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 1100 contains one or more visualization module(s) 1108. In the example of computing system 1100, computer system 1101A includes the visualization module 1108. In some embodiments, a single visualization module may be used to perform some or all aspects of one or more embodiments of the methods 400, 500, 700, 900, 1000. In alternate embodiments, a plurality of image partition aligning and stacking modules may be used to perform some or all aspects of methods 400, 500, 700, 900, 1000.

It should be appreciated that computing system 1100 is only one example of a computing system, and that computing system 1100 may have more or fewer components than shown, may combine additional components not depicted in the example embodiment of FIG. 11, and/or computing system 1100 may have a different configuration or arrangement of the components depicted in FIG. 11. The various components shown in FIG. 11 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

It is important to recognize that geologic interpretations, models and/or other interpretation aids may be refined in an iterative fashion; this concept is applicable to methods 400-700 as discussed herein. This can include use of feedback loops executed on an algorithmic basis, such as at a computing device (e.g., computing system 1100, FIG. 11), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods 400, 500, 700, 900, 1000 are illustrated and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

What is claimed is:

1. A method for visualizing a seismic attribute, comprising:
obtaining data representing a seismic image based on seismic data of at least a portion of a subterranean volume;
obtaining data representing a first seismic attribute calculated based on the seismic data;
determining one or more characteristics of one or more first attribute indicators based on the first seismic attribute, wherein at least one of the one or more characteristics comprises an orientation of the one or more first attribute indicators; and
displaying the one or more first attribute indicators in combination with the seismic image.

2. The method of claim 1, wherein displaying the one or more first attribute indicators comprises plotting the one or more first attribute indicators on the seismic image at or near a point in the seismic image from which the one or more characteristics of the one or more first attribute indicators are determined.

3. The method of claim 1, wherein the one or more characteristics further comprise a dimensional size of the one or more first attribute indicators.

4. The method of claim 3, wherein the one or more first attribute indicators comprise one or more line segments, the dimensional size comprising a length of the one or more line segments.

5. The method of claim 3, wherein the one or more first attribute indicators comprise one or more ellipsoids, the dimensional size comprising at least two semi-axes of the one or more ellipsoids.

6. The method of claim 1, wherein:
the first seismic attribute comprises dip; and
determining the one or more characteristics of the one or more attribute indicators comprises:
determining a first dimensional size based on a dominant dip; and
determining a second dimensional size based on a residual dip, or a quality metric calculated based on a combination of the dominant dip and the residual dip.

7. The method of claim 1, wherein obtaining the data representing the first seismic attribute comprises:
obtaining data representing a velocity field based on the seismic data and data representing a dip field based on the seismic data, the dip field comprising a primary dip;
decomposing the velocity field into at least a direction perpendicular to the primary dip; and
estimating velocity variation in one or more directions non-perpendicular to the primary dip based on an anisotropic approximation of the subterranean volume,
wherein displaying the one or more first indicators comprises displaying a velocity field indicator oriented parallel to a v-fast direction.

8. The method of claim 1, further comprising:
obtaining data representing a second seismic attribute based on the seismic data;
determining one or more characteristics of one or more second attribute indicators based on the second seismic attribute; and
displaying the one or more second attribute indicators in combination with the one or more first attribute indicators and the seismic image.

9. The method of claim 8, wherein the one or more second attribute indicators are at least partially embedded within the one or more first attribute indicators.

10. The method of claim 8, wherein the one or more first attribute indicators represent dip and the one or more second attribute indicators represent a velocity field.

11. A computing system comprising:
a display;
one or more processors; and
a memory system comprising one or more non-transitory computer-readable media storing instructions that, when executed by at least one of the one or more processors, cause the computing system to perform operations, the operations comprising:
obtaining data representing a seismic image based on seismic data of at least a portion of a subterranean volume;
obtaining data representing a first seismic attribute calculated based on the seismic data;
determining one or more characteristics of one or more first attribute indicators based on the first seismic attribute, wherein at least one of the one or more characteristics comprises an orientation of the one or more first attribute indicators; and
displaying, using the display, the one or more first attribute indicators in combination with the seismic image.

12. The system of claim 11, wherein displaying the one or more first attribute indicators comprises plotting the one or more first attribute indicators on the seismic image at or near a point in the seismic image from which the one or more characteristics of the one or more first attribute indicators are determined.

13. The system of claim 11, wherein the one or more characteristics further comprise a dimensional size of the one or more first attribute indicators.

14. The system of claim 13, wherein:
the one or more first attribute indicators comprise one or more line segments, the dimensional size comprising a length of the one or more line segments; or
the one or more first attribute indicators comprise one or more ellipsoids, the dimensional size comprising at least two semi-axes of the one or more ellipsoids.

15. The system of claim 11, wherein:
the first seismic attribute comprises dip; and
determining the one or more characteristics of the one or more attribute indicators comprises:
determining a first dimensional size based on a dominant dip; and
determining a second dimensional size based on a residual dip, or a quality metric calculated based on a combination of the dominant dip and the residual dip.

16. The system of claim 11, wherein obtaining the first seismic attribute comprises:
obtaining data representing a velocity field based on the seismic data and data representing a dip field based on the seismic data, the dip field comprising a primary dip;
decomposing the velocity field into at least a direction perpendicular to the primary dip; and
estimating velocity variation in one or more directions non-perpendicular to the primary dip based on an anisotropic approximation of the subterranean volume,
wherein displaying the one or more first indicators comprises displaying a velocity field indicator oriented parallel to a v-fast direction.

17. The system of claim 11, further comprising:
obtaining data representing a second seismic attribute based on the seismic data;
determining one or more characteristics of one or more second attribute indicators based on the second seismic attribute; and
displaying the one or more second attribute indicators in combination with the one or more first attribute indicators and the seismic image.

18. The system of claim 17, wherein the one or more second attribute indicators are at least partially embedded within the one or more first attribute indicators.

19. A non-transitory computer-readable medium storing instructions that, when executed by at least one processor of a computing system, cause the computing system to perform operations, the operations comprising:
obtaining data representing a seismic image based on seismic data of at least a portion of a subterranean volume;
obtaining data representing a first seismic attribute calculated based on the seismic data;
determining one or more characteristics of one or more first attribute indicators based on the first seismic attribute, wherein at least one of the one or more characteristics comprises an orientation of the one or more first attribute indicators; and
displaying the one or more first attribute indicators in combination with the seismic image.

20. The media of claim 19, wherein displaying the one or more first attribute indicators comprises plotting the one or more first attribute indicators on the seismic image at or near a point in the seismic image from which the one or more characteristics of the one or more first attribute indicators are determined.
